(19) United States
(12) Patent Application Publication
(10) Pub. No.: US 2010/0038399 A1
(43) Pub. Date: Feb. 18, 2010

(54) Stapler

(76) Inventor: Daniel Martinez, Lake City, MI (US)

Correspondence Address: ROBERT J. SAYFIE, P.C., 161 OTTAWA AVENUE NW, SUITE 407, GRAND RAPIDS, MI, 49503, US

(21) Appl. No.: 12/228,858

(22) Filed: Aug. 18, 2008

(51) Int. Cl. B25C 5/00

(52) U.S. Cl. 227/110

(57) ABSTRACT

The present invention is a stapler having a housing; a body (30) pivotally secured to the housing and a second rod extending from the body.

### BACKGROUND OF THE INVENTION

This invention relates to a stapler that can be used at remote distances. For example, up to 20-30 feet away from the user. The stapler ejects a staple upon contact with the surface as the stapler is “slapped” against the surface.

U.S. Pat. No. 4,284,223 to Salcido et al. discloses a staple gun having a contact trigger secured to an elongated tubular handle. This device is used on staple guns having triggers. This does not have a brace structure that allows for multiple-angling position of a slap-actuated staple gun.

As can be seen, there is a need for a stapler that can be used and activated by slapping the stapler against the surface to be stapled.

### SUMMARY OF THE INVENTION

An aspect of the present invention is a stapler (10), comprising: a housing (20); a body (30) pivotally secured to said housing (20); and a second rod (130) extending from said body (30).

Another aspect is a stapler (10), comprising: a housing (20); a body (30) pivotally secured to said housing (20); a second rod (130) extending from said body (30); said housing (20) has a first side (22), a second side (24) separated from said first side (22); and a bottom (21) to define a staple chamber (180) that is capable of holding staples therein; a staple biasing device (28) that is capable of being removably engaged with the staple chamber (180) to bias the staples toward the housing front (26) so the staples can be ejected upon activation; said body (30) is capable of pivoting with respect to said housing (20) about a pivot member (120); and said second rod (130) is adjustable connected to a first rod (140) by a rod length adjustment device (150), whereby said rod length adjustment device (150) may be rotated one way to secure said second rod (130) in position with respect to said first rod (140), and said rod length adjustment device (150) may be rotated another way so that the second rod (130) may slide within said first rod (140).

These and other features, aspects and advantages of the present invention will become better understood with reference to the following drawings, description and claims.

### BRIEF DESCRIPTION OF THE DRAWINGS

FIG. 1 is a pictorial view of an exemplary embodiment of the present invention;

FIG. 2 is a second pictorial of an exemplary embodiment of the present invention;

FIG. 3 is a third pictorial of an exemplary embodiment of the present invention illustrating a bottom side;

FIG. 4 is a pictorial of a partially disassembled embodiment of the present invention;

FIG. 5 is a close up pictorial of the rear of the housing and body of an exemplary embodiment of the present invention;

FIG. 6 is a pictorial is a second rod of an exemplary embodiment of the present invention; and

FIG. 7 is a pictorial of the first rod and second rod of an exemplary embodiment of the present invention.

### REFERENCE NUMERALS

10 stapler
20 housing
21 bottom
22 first side
24 second side
26 housing front
28 staple biasing device
30 body
40 body arm
50 housing arm
55 housing arm bottom portion
60 body arm aperture
70 housing arm aperture
72 second housing arm aperture
80 housing securing device
90 first body fastener
92 second rod member aperture
100 second body fastener
102 extension aperture
106 body extensions
110 length adjustable rod
120 pivot member
125 body-housing fastener
130 second rod
140 first rod
150 rod length adjustment device
160 housing pivot member aperture
170 body pivot member aperture
180 staple chamber
200 activation head
210 power source

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

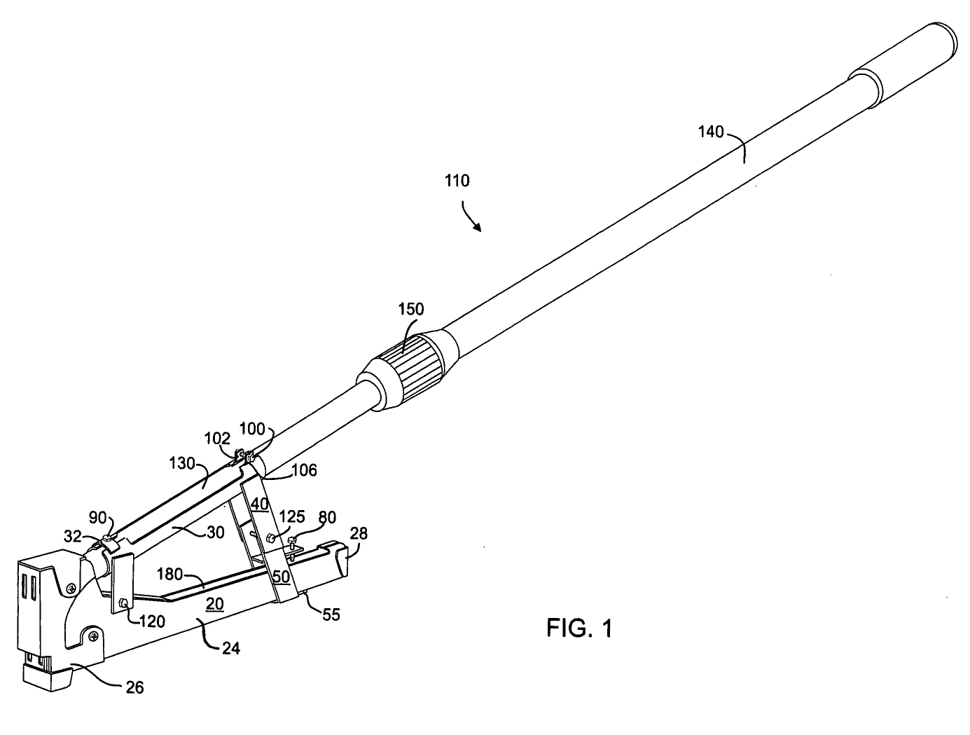

FIG. 1 illustrates an exemplary embodiment of the present invention, referred to as a stapler 10. In general, the stapler 10 is comprised of a housing 20 and a body 30. The housing 20 has a first side 22, and a second side 24, which defines a staple chamber 180 therebetween. The staple chamber 180 may receive staples therein. The staples may be biased toward the housing front 26 by a standard spring mechanism used in conventional staplers. The housing 20 may be removably secured to the body 30 by fasteners, such as a body-housing fastener 125 and a pivot member 120.

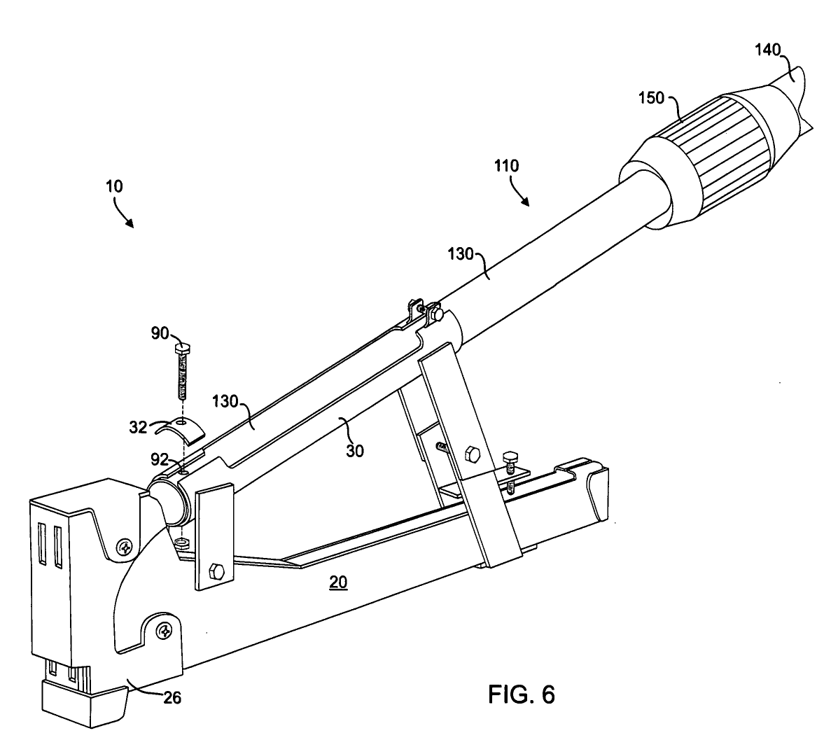

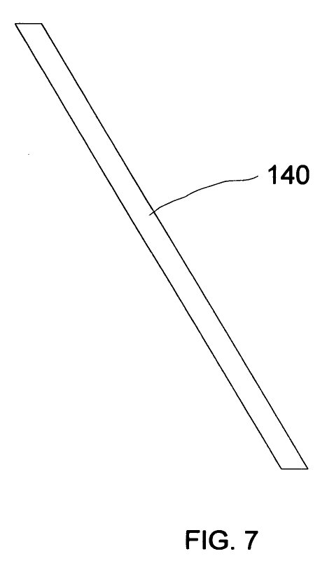

The body 30 may be removably secured to a second rod 130 by a first body fastener and a second body fastener 100. The first body fastener 90 may thread through a collar 32 to contact or enter an aperture on the second rod 130, such as a second rod aperture 92, as illustrated in FIG. 6. The fastener 90 may be threadably engaged with an aperture in the second rod 130 to secure the body 30 to the second rod 130. The body 30 may be capable of receiving a second rod 130 therein. The body 30 may have a body extension 106 extending upwardly therefrom. The body extension 106 may have an extension aperture 102 that is capable of receiving a second body fastener 100. The second body fastener 100 may be threadably engaged with the extension aperture 102 so that two body extensions 106 may be pulled toward the opposed body extension 106 by a nut and/or bolt relationship, which may cause the body 30 to tighten around the second rod 130.

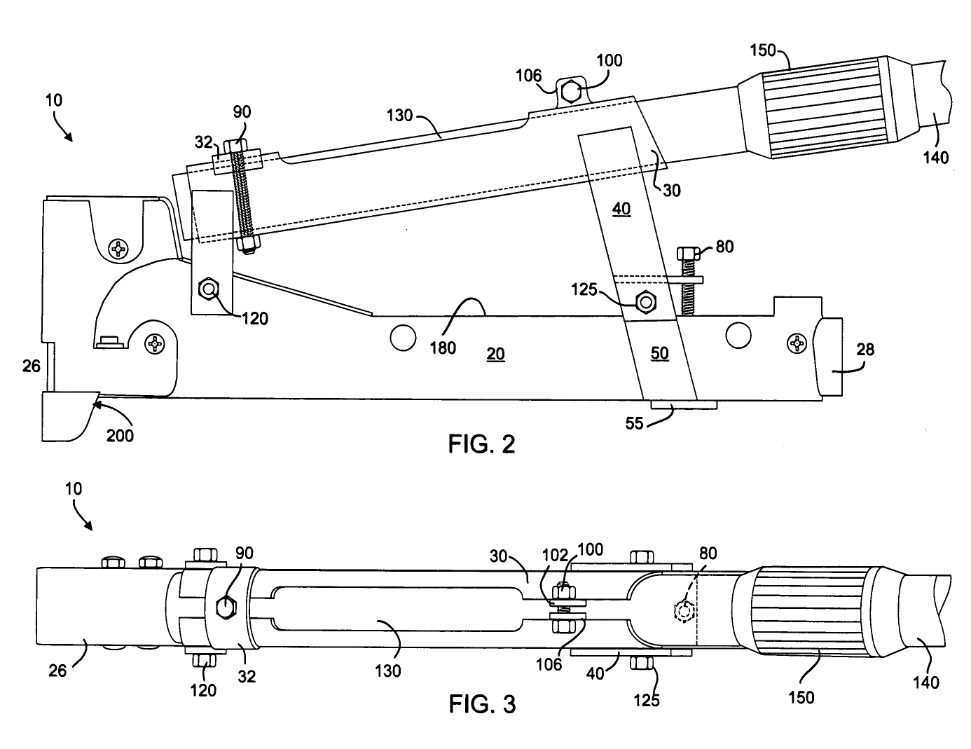

FIG. 2 illustrates the body arm 40 that may extend away from the body 30. The body arm 40 may have a body arm aperture 60 therein. The body arm aperture 60 may be capable of receiving a fastener, such as a body-housing fastener 125 as illustrated in FIG. 1 and FIG. 3. A housing arm 50 may extend upwardly from the housing first side 22 or the housing second side 24. The housing arm 50 may be disposed adjacent the body arm aperture 60.

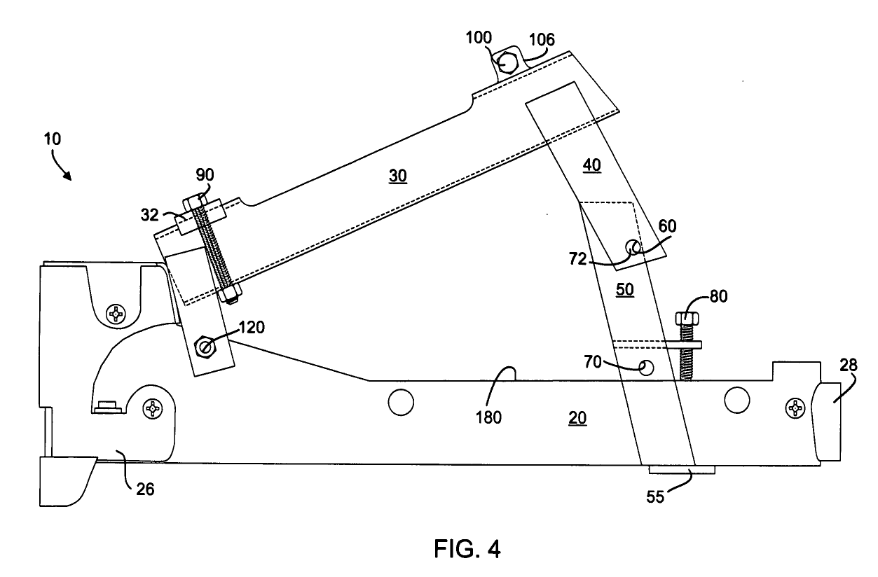

As illustrated in FIG. 4, the housing arm 50 may have a housing arm aperture 70 and a second housing arm aperture 72 disposed upwardly from the housing arm aperture 70. The body housing fastener 125 may be disposed through the body arm aperture 60 and either the housing arm aperture 70 or the second housing arm aperture 72, depending on the desired position. The body 30 may pivot about the pivot member 120. The pivot member 120 may be disposed through a body pivot member aperture 170 and the housing pivot member aperture 170 to allow the pivoting of the body 30 with respect to the housing 20 to a desired position, and secured in that position by securing the body-housing aperture 125 though the body arm aperture 60 and either the housing arm aperture 70, or the second housing arm aperture 72.

FIG. 2 illustrates how the body 30 may be oriented with respect to the housing 20 when the body arm aperture 60 is aligned with the second housing arm aperture 72. FIG. 3 illustrates how the body 30 may be oriented with respect to the housing 20 when the body arm aperture is aligned with the housing arm aperture 70. FIG. 4 also illustrates a spring activated staple biasing device 28. This is conventional and can be found in most standard staplers.

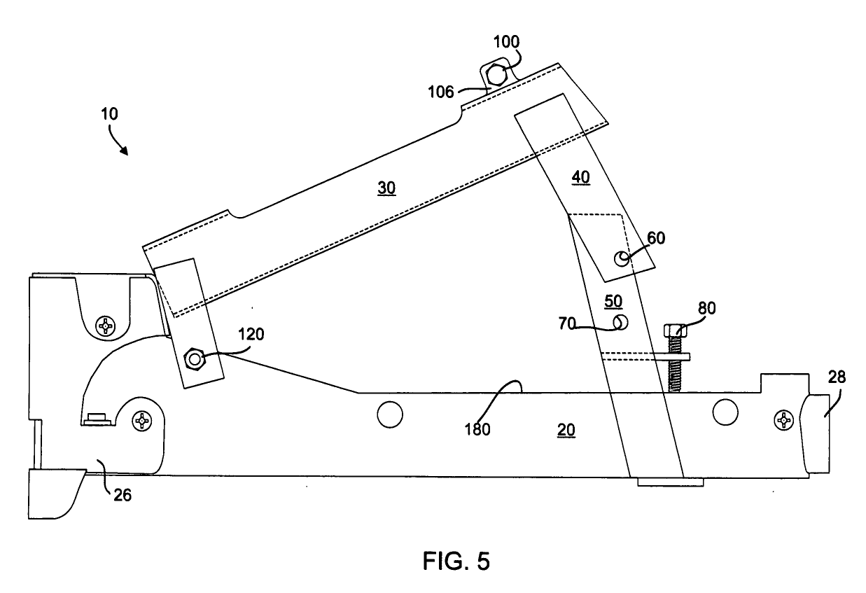

FIG. 5 illustrates the staple chamber 180, and the staple biasing device 28. The staple biasing device 28 may be able to be removed so that staples can be inserted in the staple chamber 180, and then the staple biasing device 28 may be able to be repositioned so that a spring pushes the staples towards the housing front 26, to then eject the staple in conventional fashion.

As illustrated in FIG. 1, the second body fastener 100 may be received by act to compress a collar 32 against the second rod 130. The length adjustable rod 110 may be comprised of the first rod 140, second rod 130 being slidably received by the first rod 140, and a rod length adjustment device 150 being capable of threadably engaging with the second rod to tighten against the first rod 130 to secure the first rod 130 in position with respect to the second rod 140.

The dimensions and sizes of the stapler 10 and its elements or components may vary. For example, the first rod 140 or second rod 130 may be of various lengths, diameters, or even different cross sectional shapes. Also, the stapler 10 may be able to accommodate different size staples by having a respectively different sized housing, or a housing of the same size, but using a staple adapter.

The materials of which the elements are made may vary. The stapler's 10 various components may be constructed from metals, composites, plastics, glass, or woods, or a combination of the aforesaid materials. Other components may be added to improve on functions. For example, ball bearings may be used to aid in the motion of surfaces or components.

Also, the movements and displacements herein may be performed manually, robotically, or by other means.

The staple is discharged by conventional means when the activation head 200 activates the hammer (internal); and the hammer hits the staple from behind. Usually the hammer is the same size as the staple to stop any distortion. In an alternate embodiment in an electric or pneumatic gun the hammer is powered accordingly; thus the user may activate a power source 210 (not illustrated), such as electronic or pneumatic power to discharge the staple.

It should be understood, of course, that the foregoing relates to exemplary embodiments of the invention and that modifications may be made without departing from the spirit and scope of the invention as set forth in the following claims.

I claim:

1. A stapler (10), comprising:
a housing (20);
a body (30) pivotally secured to said housing (20); and
a second rod (130) extending from said body (30).

2. The stapler (10) of claim 1, wherein said housing has a first side (22), a second side (24) separated from said first side (22); and a bottom (21) to define a staple chamber (180) that is capable of holding staples therein;
a staple biasing device (28) that is capable of being removably engaged with the staple chamber (180) to bias the staples toward the housing front (26) so the staples can be ejected upon activation.

3. The stapler (10) of claim 1, wherein said body (30) is capable of pivoting with respect to said housing (20).

4. The stapler (10) of claim 1, wherein said body (30) is capable of pivoting with respect to said housing (20) about a pivot member (120).

5. The stapler (10) of claim 1, wherein said second rod (130) is adjustably connected to a first rod (140).

6. The stapler (10) of claim 1, wherein said second rod (130) is adjustable connected to a first rod (140) by a rod length adjustment device (150), whereby said rod length adjustment device (150) may be rotated one way to secure said second rod (130) in position with respect to said first rod (140), and said rod length adjustment device (150) may be rotated another way so that the second rod (130) may slide within said first rod (140).

7. The stapler of claim 6, wherein the staple is discharged via the activation hammer 200 contacting a surface.

8. A stapler (10), comprising:
a housing (20);
a body (30) pivotally secured to said housing (20);
a second rod (130) extending from said body (30); said housing (20) has a first side (22), a second side (24) separated from said first side (22); and a bottom (21) to define a staple chamber (180) that is capable of holding staples therein;
a staple biasing device (28) that is capable of being removably engaged with the staple chamber (180) to bias the staples toward the housing front (26) so the staples can be ejected upon activation;
said body (30) is capable of pivoting with respect to said housing (20) about a pivot member (120); and
said second rod (130) is adjustable connected to a first rod (140) by a rod length adjustment device (150), whereby said rod length adjustment device (150) may be rotated one way to secure said second rod (130) in position with respect to said first rod (140), and said rod length adjustment device (150) may be rotated another way so that the second rod (130) may slide within said first rod (140).
